(19) United States
(12) Patent Application Publication
(10) Pub. No.: US 2024/0331563 A1
(43) Pub. Date: Oct. 3, 2024

(54) SYSTEM AND METHOD FOR TEACHING A USER A LANGUAGE USING MEDIA CONTENT

(71) Applicant: Spotify AB, Stockholm (SE)

(72) Inventors: Jackie DOREMUS, Los Osos, CA (US); Aaron DAVIDSON, Long Island City, NY (US); Katharine HARVEY, Seattle, WA (US); Joyce Sze Chung CHAN, Los Angeles, CA (US); Rosemary Ellen JONES, Boston, MA (US); Jakob ZEITLER, Oxford (GB); Chenyu WANG, Rogers, AR (US); Luisa WEINBERG, New York, NY (US); Mivic OLLENNU, London (GB); Ashkan NASSERI, Brooklyn, NY (US)

(73) Assignee: Spotify AB, Stockholm (SE)

(21) Appl. No.: 18/194,384

(22) Filed: Mar. 31, 2023

(51) Int. Cl. G09B 7/06; G09B 19/06

(52) U.S. Cl. CPC G09B 7/06; G09B 19/06

(57) ABSTRACT

Systems and methods for teaching a user a language using media content are provided. Translation prompts may be automatically presented to the user as the user listens to music on a computing device. The translation prompts may present a question to the user asking the user to translate a lyric in the music. The translation prompts may be personalized for the user based on the user's skill level and language learning needs. Music may also be selected for the user based on the user's music taste and the music having lyrics that are appropriate for the user's skill level and language learning needs.

### BACKGROUND

Learning multiple languages can provide numerous benefits to people, especially as the world becomes more global. Many career paths may be advanced by learning a foreign language as more businesses seek opportunities to engage in international markets and perform deals with foreign clients. Some jobs may even require applicants to know multiple languages. Additionally, learning a foreign language can make traveling to a country that speaks that language easier and allows travelers to explore outside of tourist bubbles. Beyond work and travel, learning languages may also provide cognitive benefits. Studying a foreign language has been shown to increase brain functions, such as multitasking and problem solving, as well as memory.

### SUMMARY

In general, the present disclosure relates to a system and method for teaching a user a language using media content. As a user listens to a song, or a segment of a song, a translation prompt may be presented to query the user about a translation of a lyric of the song—or segment.

In a first aspect, a method of teaching a user a language using media content is provided. At least a segment of a song is played on a computing device. The segment of the song has a lyric. A time at which the lyric will be played is determined. A translation prompt for the lyric is presented at the computing device at a time that is substantially the same as the time at which the lyric is played. The translation prompt is presented automatically without an input from the user at a time during which the segment is played.

In a second aspect, a system for teaching a user a language using media content is provided. The system comprises a computing device. The computing device is configured to play at least a segment of a song. The segment has a lyric. The computing device is further configured to determine a time at which the lyric will be played and present a translation prompt for the lyric at a time that is substantially the same as the time at which the lyric is played. The translation prompt is automatically presented without an input from the user at a time during which the segment is played.

In a third aspect, a media delivery system for teaching a user in a language using media content is provided. The media delivery system is configured to stream at least a segment of a song to a computing device, select a lyric from the segment based on a skill level of the user and a language learning need of the user, determine a timestamp of a time at which the lyric is played, determine a translation of the lyric, and compile the lyric, the timestamp, and the translation to be used for a translation prompt for the user. The translation prompt for the lyric is automatically presented to the user on the computing device at a time that is substantially the same as the time at which the lyric is played without an input from the user at a time during which the segment is played.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic block diagram of an example of a media play back system for presenting translation prompts.

FIG. 2 illustrates a schematic block diagram of another example of a media playback system shown in FIG. 1.

FIG. 3 illustrates an example embodiment of a translation prompt in a flashcard style.

FIG. 4 illustrates an example embodiment of a translation prompt in a fill-in-the-blank style.

FIG. 5 illustrates an example embodiment of a translation prompt in a multiple-choice style.

FIG. 6 illustrates an example embodiment of a translation prompt in a true/false style.

FIG. 7 illustrates an example embodiment of a translation prompt in a written or spoken response style.

FIG. 8 illustrates a schematic block diagram of an example of a language training engine shown in FIG. 2.

FIG. 9 illustrates an example embodiment of a lyrics database shown in FIG. 8.

FIG. 10 illustrates a flowchart of an example method for presenting translation prompts.

FIG. 11 illustrates a flowchart of an example method for compiling personalized language training playlists for a user.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used herein, the term “including” as used herein should be read to mean “including, without limitation,” “including but not limited to,” or the like. The term “substantially” as used herein is a broad term and is to be given its ordinary and customary meaning to a person of ordinary skill in the art (and is not to be limited to a special or customized meaning), and furthermore refers without limitation to being largely but not necessarily wholly that which is specified.

As briefly described above, embodiments of the present disclosure are directed to a system and method for teaching a user a language using media content. For ease of understanding, many example aspects of the embodiments described herein are described in relation to music or songs. This description is not intended to limit the application of the example embodiments presented herein. In fact, after reading the following description, it will be apparent to one skilled in the relevant art(s) how to implement the following example embodiments in alternative embodiments involving alternative forms of media content, such as podcasts, audiobooks, advertisements, or other media content including an audio component. Further, even if not explicitly stated in an example embodiment, segments of media content may be used instead of an entire piece of media content—i.e., a segment of a song may be used instead of an entire song.

Similarly, while some examples embodiments may describe the expression of vocalized content within the media content as “lyrics,” other forms of content may be used. For example, with respect to a podcast or an audiobook, a transcript of the podcast or audiobook may be used.

In example aspects, a translation prompt is presented to the user while a song, or a segment of a song, is playing. The translation prompt presents the user with a question about a translation of a lyric in the song—or segment. This presentation is done automatically without any input from the user while the song is playing: the translation prompt may be generated with a timestamp of when the associated lyric is played in the song, allowing the translation prompt to be presented at substantially the same time as the lyric is played. It may be presented automatically without any input from the user while the song (or segment) is playing. Additionally, the translation prompt may be personalized for the user, presenting questions that are at an appropriate difficulty for the user's skill level and address a language learning need of the user.

By presenting translation prompts as a user listens to music, the user can learn a new language more quickly than through other language learning methods. The rhythm and repetitive patterns in music may aid in the memorization of words. Personalizing the translation prompts to be at the user's skill level and address the user's language learning needs may also increase the rate at which the user learns the language. Additionally, translation prompts may be generated on the fly, further increasing the level of personalization by allowing users to select the music they want to listen to and use to study, rather than being limited to pre-generated lessons that may not include music that fits the users' tastes. Ultimately this provides a language learning experience for the user that is both engaging and efficient.

In further aspects, in addition to personalizing the translation prompts, other language learning exercises can be personalized for the user, with songs being selected specifically for the user. By selecting from a database of commercially available, professional music, songs can be presented to the user that not only include lyrics that fit with the user's skill level and language learning needs, but also fit with the user's music tastes. Thus, users can learn a new language while also being introduced to new music that they might like.

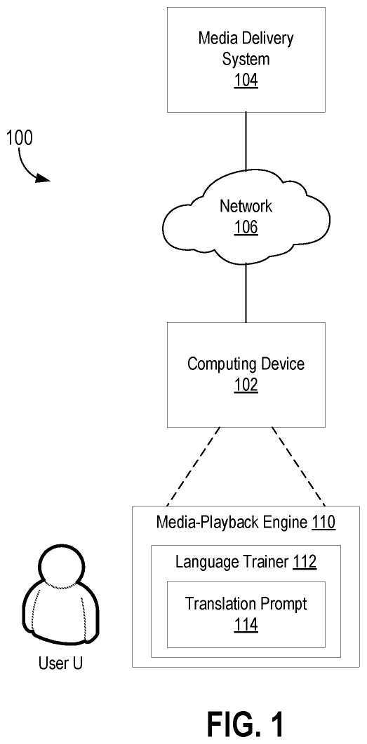

Turning now to FIG. 1, a schematic block diagram illustrating an example of a media play back system 100 for presenting translation prompts 114 is shown. In this example, the media play back system 100 includes a computing device 102 and a media delivery system 104. The computing device 102 and media delivery system 104 communicate with each other across a data communication network 106. The example computing device 102 includes a media-playback engine 110 that includes a language trainer 112. The language trainer 112 presents translation prompts 114 to a user U.

In the illustrated example, the user U listens to media content, such as music, through the media-playback engine 110 on the computing device 102. In embodiments, the computing device 102 may be a smartphone or a personal computer. The media-play back engine 110 may be, for example, a software application running on the computing device 102. In some embodiments, the media content is obtained from the media delivery system 104, such as by streaming the media content from the media delivery system 104 to the media-play back engine 110 on the computing device 102. In alternative embodiments, the media content is stored locally on the computing device 102, making communication with the media delivery system 104 not required.

The media delivery system 104 is a system that provides media content to the computing device 102. In one example, the media delivery system 104 is a media streaming service that streams media content across the Internet (network 106) to the computing device 102 for play back to the user U.

The network 106 is one or more data communication networks that individually or collectively provide a data communication channel between the computing device 102 and the media delivery system 104. An example of the network 106 is the Internet. The network 106 can include wired and wireless data communication channels, such as cellular, WIFI, BLUETOOTH™, LoRa, wired, and fiber optic communication channels.

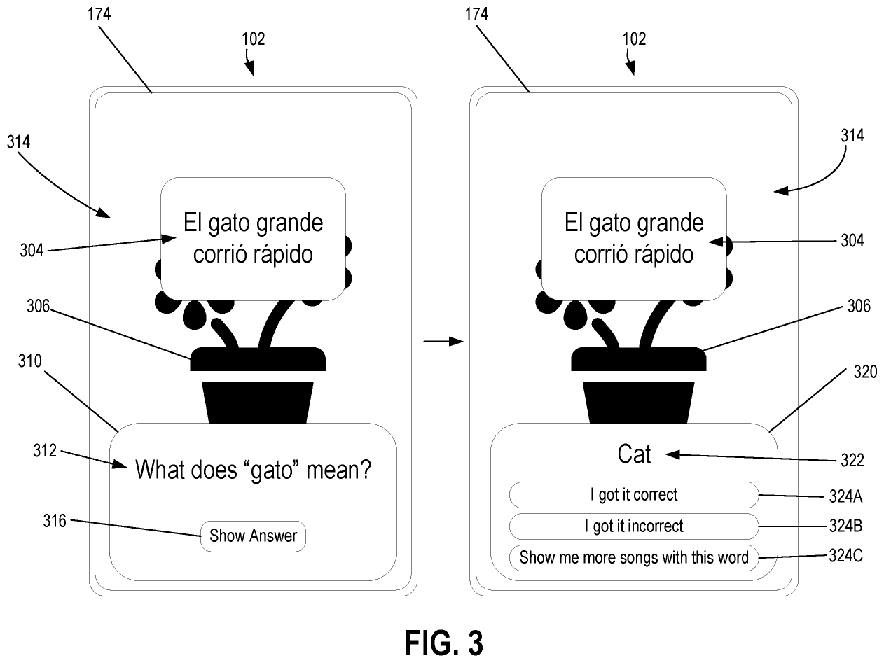

As the media-play back engine 110 plays media content for the user U, the language trainer 112 may assist the user U in learning a language. This may be a foreign language for the user U. Throughout the play back of the media content, the language trainer 112 may present the user U with translation prompt 114. The language trainer 112 may work with components of the media delivery system 104 to generate the translation prompt 114. Alternatively, the language trainer 112 may generate translation prompts on its own, or it may only display translation prompt 114 that were generated by components of the media delivery system 104. In embodiments, these translation prompt 114 may present the user U with a question about a lyric within the media content asking the user U to translate the lyric. The translation prompt 114 is described in more detail herein, with examples of translation prompts 114 shown in FIGS. 3-7.

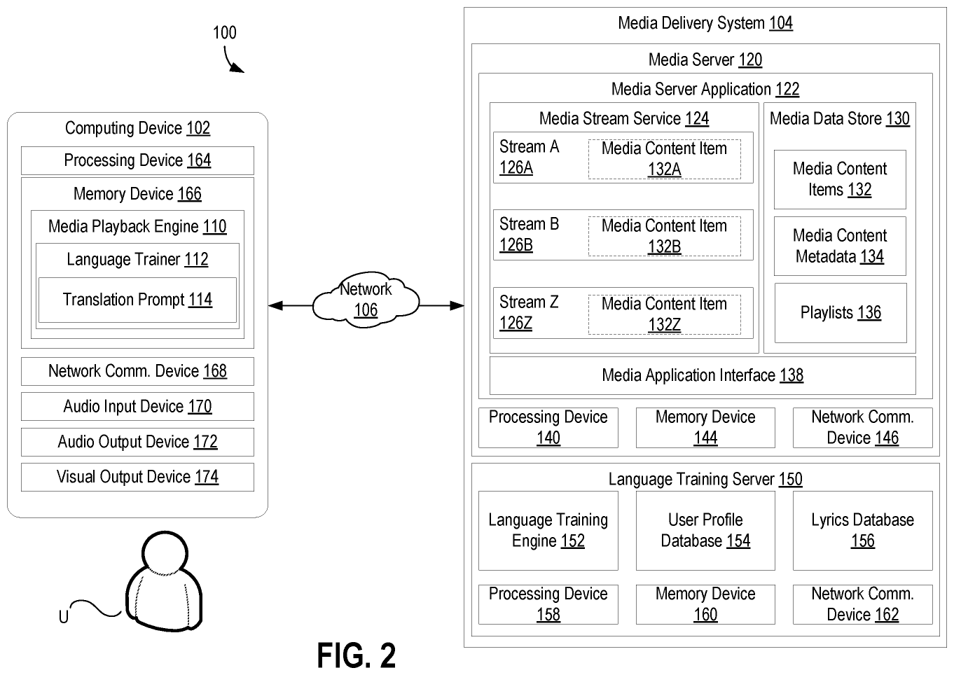

FIG. 2 illustrates a schematic block diagram illustrating another example of the media play back system 100 shown in FIG. 1. In this example, the media play back system 100 includes the computing device 102 and the media delivery system 104. The network 106 is also shown for communication between the computing device 102 and the media delivery system 104.

As described herein, the computing device 102 operates to play media content items to a user U and provides a language trainer 112 that aids the user U in learning a language. In some embodiments, the computing device 102 operates to play media content items 132 that are provided (e.g., streamed, transmitted, etc.) by a system remote from the computing device 102 such as the media delivery system 104, another system, or a peer device. Alternatively, in some embodiments, the computing device 102 operates to play media content items stored locally on the computing device 102. Further, in at least some embodiments, the computing device 102 operates to play media content items that are stored locally as well as media content items provided by remote systems.

In some embodiments, the computing device 102 includes a processing device 164, a memory device 166, a network communication device 168, an audio input device 170, an audio output device 172, and a visual output device 174. In the illustrated example, the memory device 166 includes the media-playback engine 110 and the language trainer 112. Other embodiments of the computing device 102 include additional, fewer, or different components. Examples of computing devices include a smartphone, a smart speaker, and a computer (e.g., desktop, laptop, tablet, etc.).

In some embodiments, the processing device 164 comprises one or more processing devices, such as central processing units (CPU). In other embodiments, the processing device 164 additionally or alternatively includes one or more digital signal processors, field-programmable gate arrays, or other electronic circuits. In some embodiments, the processing device 164 includes at least one processing device that can execute program instructions to cause the at least one processing device to perform one or more functions, methods, or steps as described herein.

The memory device 166 operates to store data and program instructions. In some embodiments, the memory device 166 stores program instructions for the media-play back engine 110 that enables playback of media content items received from the media delivery system 104, and for the language trainer 112. As described herein, the media-play back engine 110 is configured to communicate with the media delivery system 104 to receive one or more media content items—e.g., through the media content streams 126 (including media content streams 126A, 126B, and 126Z).

The memory device 166 includes at least one memory device. The memory device 166 typically includes at least some form of computer-readable media. Computer readable media include any available media that can be accessed by the computing device 102. By way of example, computer-readable media can include computer readable storage media and computer readable communication media.

Computer readable storage media includes volatile and nonvolatile, removable and non-removable media implemented in any device configured to store information such as computer readable instructions, data structures, program modules, or other data. Computer readable storage media includes, but is not limited to, random access memory, read only memory, electrically erasable programmable read only memory, flash memory and other memory technology, compact disc read only memory, blue ray discs, digital versatile discs or other optical storage, magnetic cassettes, magnetic tape, magnetic disk storage or other magnetic storage devices, or any other medium that can be accessed by the computing device 102. In some embodiments, computer readable storage media is non-transitory computer readable storage media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The network communication device 168 is a device that operates to communicate data across the network 106. The network communication device 168 allows the computing device 102 to communication with remote devices, such as with the media server 120 and the language training server 150 of the media delivery system 104. Examples of the network communication device 168 include wired and wireless data communication devices, such as a cellular, WIFI, BLUETOOTH™, LoRa, and wired (e.g., Ethernet) communication device.

Some embodiments include an audio input device 170 that operates to receive audio input, such as voice input provided by the user. The audio input device 170 typically includes at least one microphone. In some embodiments, the audio input device 170 detects audio signals directly, and in other embodiments, the audio input device 170 communicates with another device that detects the audio signals (such as through a Bluetooth-connected microphone).

The audio output device 172 operates to output audible sounds, such as the media content, auditory presentations of translation prompts 114, and other audio outputs, such as audio cues. In some embodiments, the audio output device 172 generates media output to play media content to the user U. Examples of the audio output device 172 include a speaker, an audio output jack, and a Bluetooth transceiver (such as for communication with a Bluetooth-connected speaker). In some embodiments, the audio output device 172 generates an audio output directly, and in other embodiments, the audio output device 172 communicates with another device that generates the audio output. For example, the audio output device 172 may transmit a signal through an audio output jack or a Bluetooth transmitter that can be used to generate the audio signal by a connected or paired device such as headphones or a speaker.

Some embodiments also include a visual output device 174. The visual output device 174 includes one or more light-emitting devices that generate a visual output. Examples of the visual output device 174 includes a display device (which can include a tough-sensitive display device) and lights such as one-or-more light-emitting diodes (LEDs). The visual output device 174 may operate to display translation prompts 114 visually to the user U.

Still with reference to FIG. 2, the media delivery system 104 includes one or more computing devices, such as the media server 120 that provides media content items 132 to the computing device 102, and the language training server 150 that performs one or more language training operations to support the language trainer 112. Each of the media server 120 and the language training server 150 can include multiple computing devices in some embodiments. Although shown as separate servers, the media server 120 and the language training server 150 may be the same server.

In some embodiments, the media delivery system 104 operates to transmit media content items 132 to one or more media play back devices such as the computing device 102.

In this example, the media server 120 comprises a media server application 122, a processing device 140, a memory device 144, and a network communication device 146. The processing device 140, memory device 144, and network communication device 146 may be similar to the processing device 164, memory device 166, and network communication device 168 respectively, which have been previously described.

In some embodiments, the media server application 122 operates to stream music or other audio, video, or other forms of media content. The media server application 122 includes a media stream service 124, a media data store 130, and a media application interface 138.

The media stream service 124 operates to buffer media content such as media content items 132 (including 132A, 132B, and 132Z) for streaming to one or more streams 126 (including 126A, 126B, and 126Z).

The media application interface 138 can receive requests or other communication from the media playback devices (such as the computing device 102) or other systems, to retrieve media content items from the media delivery system 104. For example, in FIG. 2, the media application interface 138 receives communications from the media-play back engine 110 of the computing device 102.

In some embodiments, the media data store 130 stores media content items 132, media content metadata 134, and playlists 136. The media data store 130 may comprise one or more databases and file systems. Other embodiments are possible as well. As noted above, the media content items 132 may be audio, video, or any other type of media content, which may be stored in any format for storing media content. For example, media content items 132 may be songs, audiobooks, podcasts, or advertisements. Media content items may also be segments of any of the previously listed examples.

The media content metadata 134 operates to provide information associated with the media content items 132. In some embodiments, the media content metadata 134 includes one or more of title, artist, lyrics, album name, length, genre, mood, era, or other media metadata, as described herein.

The playlists 136 operate to identify one or more of the media content items 132. In some embodiments, the playlists 136 identify a group of the media content items 132 in a particular order. In other embodiments, the playlists 136 merely identify a group of the media content items 132 without specifying a particular order. Some, but not necessarily all, of the media content items 132 included in a particular one of the playlist 136 are associated with a common characteristic such as a common genre, mood, or era. As described herein, playlists may be generated for the user to assist in the user's language learning experience.

In this example, the language training server 150 includes a language training engine 152, a processing device 158, a memory device 160, and a network communication device 162.

In some embodiments, any one or more of the functions, methods, and operations described herein as being performed by the language training server 150—or components of the language training server 150, such as the language training engine 152—can alternatively be performed by the language trainer 112. This may include embodiments where the media delivery system 104 does not include a language training server 150 and embodiments where the language training server 150 cooperates with the language trainer 112 and the functions are split between those components.

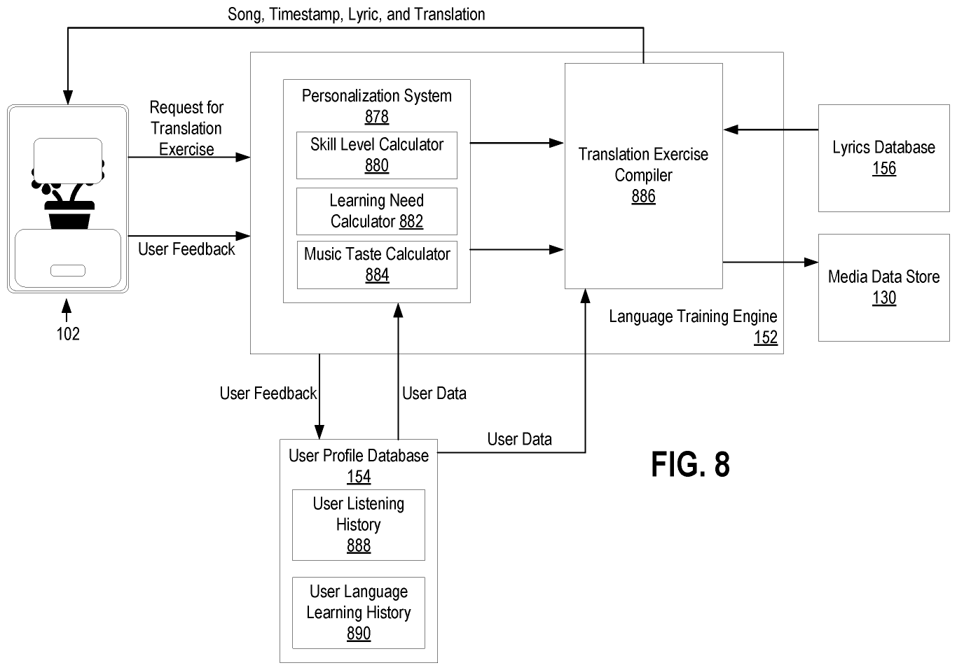

The language training engine 152 can operate on a single computing device, or by cooperation of multiple computing devices. For example, the language training engine 152 can operate solely on the computing device 102 or solely on the language training server 150. Alternatively, portions of the language training engine 152 can be performed by one or more other computing devices, such as by data communication between the computing device 102 and the media delivery system 104. In the example shown in FIG. 2, the media delivery system 104 includes the language training engine 152. The language training engine 152 can perform any one or more of the operations described herein, such as with reference to FIG. 8.

The processing device 158, memory device 160, and network communication device 162 may be similar to the processing device 164, memory device 166, and network communication device 168 respectively, which have each been previously described.

In various embodiments, the network 106 includes one or more data communication links, which may include multiple different types. For example, the network 106, can include wired and/or wireless links, including BLUETOOTH™, ultra-wideband (UWB), 802.11, ZigBee, cellular, LoRa, and other types of wireless links. Furthermore, in various embodiments, the network 106 is implemented at various scales. For example, the network 106 can be implemented as one or more local area networks (LANs), metropolitan area networks, subnets, wide area networks (such as the Internet), or can be implemented at another scale. Further, in some embodiments, the network 106 includes multiple networks, which may be of the same type or of multiple different types.

Although FIG. 2 illustrates only a single computing device 102 in communication with a single media delivery system 104, in accordance with some embodiments, the media delivery system 104 can support the simultaneous use of multiple computing devices 102. Additionally, the computing device 102 can simultaneously access media content from multiple media delivery systems 104.

FIGS. 3-7 depict various example embodiments of translation prompts. While these examples are depicted, it should be known that translation prompts are not limited just to the depicted embodiments: some alternative embodiments may combine features from multiple of the depicted embodiments, and other alternative embodiments may add features not shown in the depicted embodiments. Additionally, while the example embodiments shown include Spanish lyrics and English prompts, any combination of two languages may be used, with the lyrics being in a target language of the user and the rest of the prompt being in a language that the user understands.

The translation prompts in the illustrated examples are shown being presented visually on a visual output device of a computing device (e.g., visual output device 174 of computing device 102 in FIG. 2). In various embodiments, additionally or alternatively, the translation prompt may be presented auditorily, with a spoken version of the translation prompt being played to a user through an audio output device of a computing device. In further embodiments, the translation prompts may be presented both visually and auditorily, or some aspects may be presented visually and other aspects may be presented auditorily. The computing device on which the translation prompts are presented may be a smartphone, computer, or any other computing device as explained above. In the illustrated embodiment, the visual output device is a touchscreen, allowing a user to interact with the visual output device to provide input to the computing device. In alternative embodiments, different components may be used to provide input to the computing device.

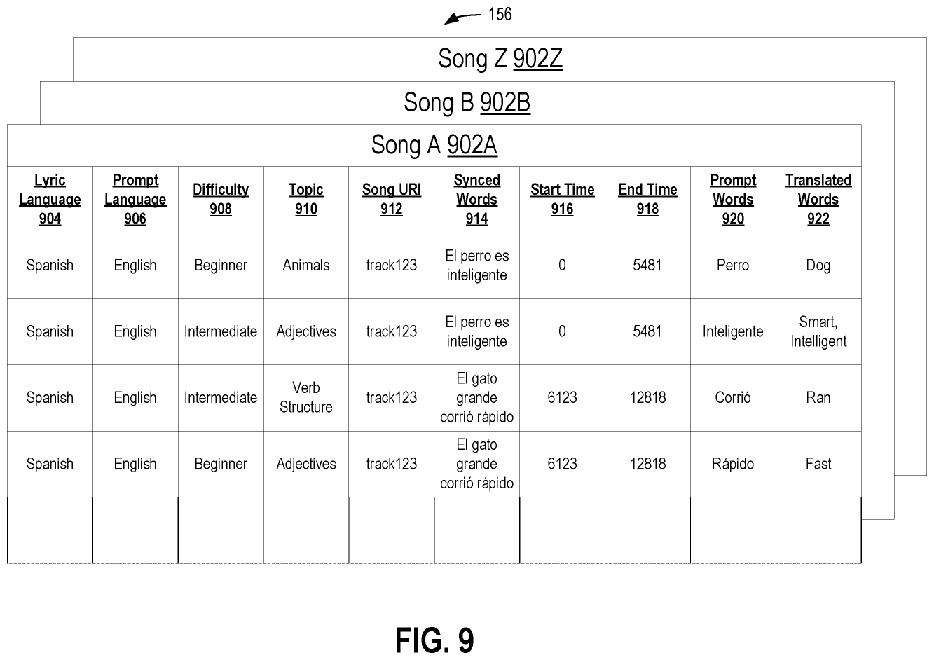

In general, the translation prompts are presented to a user as the user listens to media content, such as music. The translation prompt may present the user with a question regarding a translation of words in the media content. The translation prompt may be presented at substantially the same time as the word is pronounced in the media content. For example, as a user listens to a song, a translation prompt may be presented asking the user to translate a word or phrase in the lyrics of the song as the lyric is played. Because the lyric may be a part of a phrase that has a start time and an end time (as described herein, for example, with relation to FIG. 9), the translation prompt may be presented between the start time and the end time of the phrase. Alternatively, the translation prompt may be presented shortly before or shortly after the lyric or phrase is played—e.g., within a second of when the lyric or phrase is played. The translation prompt may be presented automatically without any input from the user while the song is playing: the user need not interact with a presentation of the lyrics during the song to get a translation prompt to be presented for a word or phrase in the lyrics. When the translation prompt is presented, the song may be paused to allow the user to answer the translation prompt. Alternatively, the song may continue to play as the user answers the translation prompt.

Similarly, the user may be presented with translation prompts as he listens to segments of songs, rather than listening to a song in its entirety. In further embodiments, media content may include audiobooks, podcasts, advertisements, or any other form of content that includes an audio component that has words. With these alternative forms of media content, expression of vocalized content can be used other than lyrics. For example, with respect to a podcast or an audiobook, a transcript of the podcast or audiobook may be used.

Translation prompts may be used as the user practices in a number of different learning modes. As described herein, the user may listen to media content that he has selected, with translation prompts being generated on the fly to allow for the user to learn while listening to any media content in his target language. As described herein, the translation prompts may be personalized for the user based on the user's skill level and language learning needs.

In an alternative example learning mode, the user may practice with a single piece of media content, starting with just a segment of the media content and progressing to the full piece of media content. For example, if the user is trying to learn the lyrics to a song, the user may first be presented with just a segment of the song, such as the chorus or the first verse, and may be presented with translation prompts for this segment of the song. Once the user learns that segment of the song—which may be indicated by an accuracy of user responses to the translation prompts—the user may be presented with additional segments of the song. The user may focus on the additional segment individually or the additional segment may be added on to the learned segment to create one longer segment. As the user continues to learn each of the new segments of the song, he may be presented with further segments until he has learned the entire song.

In another example learning mode, the user listens to media content selected for the user in an endless feed, with translation prompts presented for each piece of media content in the endless feed. The feed is “endless” in the fact that it could go on perpetually: media content may be consistently selected and added to a queue of media content through which the user can advance. At any point, the user can choose to leave the endless feed.

The media content selection for the endless feed may be personalized for the user based, at least in part, on the user's skill level and language learning needs. In an embodiment, the media content in the endless feed is songs that are selected based on the user's music tastes, in addition to skill level and language learning needs. In alternative embodiments, segments of songs, rather than the whole song, may be used in the endless feed.

The user may also select from pre-generated learning content that has media content already selected and/or translation prompts already generated. In an example, the pre-generated content includes a playlist of songs. As described herein, the playlist may be generated at the request of the user and may be personalized for the user based on the user's music tastes, skill level, and language learning needs. The songs may have a common characteristic, such as having lyrics that include the same or similar words or that include words of a common language learning topic—e.g., greetings, food items, or weather. The songs in the playlist may also have lyrics share a similar translation difficulty—e.g., beginner, intermediate, or advanced-so that the user can practice with translation prompts that match his skill level. Alternatively, the user can create and save his own playlist of songs.

Translation prompts for the songs in the playlist may be pre-generated as well. In an embodiment, each playthrough of the playlist of songs may present each of the pre-generated translation prompts to the user in the same way each time. In alternative embodiments, only a subset of the pre-generated translation prompts is presented during a playthrough of the playlist of songs, where a different subset is presented on each playthrough. This allows for the user to get different learning experiences on multiple playthroughs of the playlist.

Although the previous example of playlists has been described with respect to songs, it should be understood that playlists may be created for any form of media content.

In embodiments of the media play back system that include a media delivery system with a language training server and language training engine that communicate with a computing device over a network, such as the media playback system 100 depicted in FIG. 2, the use of pre-generated content may allow the user to learn with translation prompts even if the user's computing device is not connected to the network to communicate with the media delivery system. The user may download the pre-generated content at a time at which a connection with the media delivery system is available, and then the user can access the pre-generated content at any time while it is stored on the computing device.

Turning to FIG. 3, a first example of a translation prompt 314 is shown in a flashcard style. In the example shown, the translation prompt 314 includes a presentation of a lyric 304, a first flashcard user interface 310, and a second flashcard user interface 320. Although the translation prompt 314 includes multiple flashcard user interfaces 310 and 320, one may be presented on the visual output device 174 at a time. The translation prompt 314 may be presented over an image 306. In the illustrated embodiment, the image 306 is an image of a flowerpot. In alternative embodiments, the image 306 may be related to the media content for which the translation prompt 314 is presented. For example, if the media content is a song, the image 306 may be an image of the artist of the song, or it may be an image from a music video of the song. In alternative embodiments, a video may be presented behind the translation prompt 314, instead of the image 306.

The first flashcard user interface 310 includes a question 312 asking the user to translate a word in the in the lyric. In the illustrated example, the lyric is “el gato grande corrió rápido.” and the question 312 asks the user to translate the word “gato.” In this example, the user is asked to translate a single word: however, in alternative embodiments, the user may be asked to translate multiple words or a phrase.

The illustrated first flashcard user interface 310 further includes a selectable button 316 that the user can select to show an answer 322 to the question 312. Upon selection of the selectable button 316, the visual output device 174 is updated to display the second flashcard user interface 320. In alternative embodiments, the first flashcard user interface 310 does not include the selectable button 316. In such embodiments, the visual output device 174 may be automatically updated to display the second flashcard user interface 320 after a predetermined amount of time has passed since the first flashcard user interface 310 was presented. In further embodiments, only a single flashcard user interface is used, and information that is described below as being included in the second flashcard user interface 320 is instead included in the first flashcard user interface 310. In such an embodiment, the selectable button 316 may still be used to show the answer 322 to the question 312, and selection of the button 316 causes the additional information to be displayed on the first flashcard user interface 310.

The second flashcard user interface 320 displays the answer 322 to the question 312. The second flashcard user interface 320 also includes at least one feedback button 324 that allows the user to indicate whether he answered the question 312 correctly. In the illustrated embodiment, the second flashcard display includes three feedback buttons 324A, 324B, and 324C. A first feedback button 324A allows the user to indicate that he got the answer correct. A second feedback button 324B allows the user to indicate that he got the answer incorrect. As discussed herein, feedback from the user about whether he answered a translation prompt 314 correctly may be used to update a user profile of the user that may include a user language learning history.

A third feedback button 324C allows the user to request to see more media content—in this case, songs—with the word from the lyric 304 that was included in the question 312. As discussed herein, in response to the user selecting this feedback button 324C, a playlist of media content may be created, with each piece of media content in the playlist containing the word that was used in the lyric 304. With this playlist, the user may listen to the media content and be presented with more translation prompts, some of which may include questions about the word for which the playlist was generated.

In alternative embodiments, the translation prompt 314 does not include the presentation of the lyric 304. For example, if the user has a language learning need to practicing listening, the lyric 304 may not be presented, requiring the user to focus more on listening to the song and hearing the lyric 304 as it is sung.

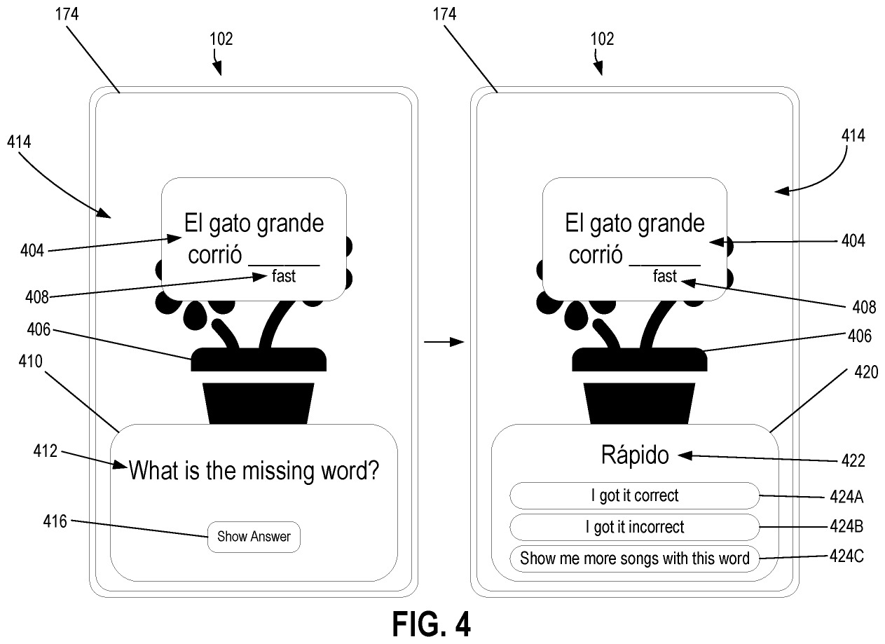

FIG. 4 illustrates a second example embodiment of a translation prompt 414 in a fill-in-the-blank style. Similar to the previous example in FIG. 3, this translation prompt 414 includes a presentation of a lyric 404, a first flashcard user interface 410 and a second flashcard user interface 420. However, in this example, a word in lyric 404 is missing in the presentation of the lyric 404, and a translation 408 of the word is included instead. In alternative embodiments, multiple words may be missing from the lyric 404 and multiple translations 408 may be given, one for each of the missing words.

In this example, the first flashcard user interface 410 includes a question 412 asking the user to fill in the missing word in the lyric 404. In some embodiments, the question 412 may be presented in the form of a statement, such as “Fill in the missing word.” The first flashcard user interface 410 also includes a selectable button 416 that the user can select to show an answer 422. Like with the example if FIG. 3, selection of the button 416 updates the visual output device 174 to display the second flashcard user interface 420.

The second flashcard user interface 420 includes similar features as the second flashcard user interface 320 in FIG. 3: the answer 422 and at least one feedback button 424. These features have the same functions as the ones described above.

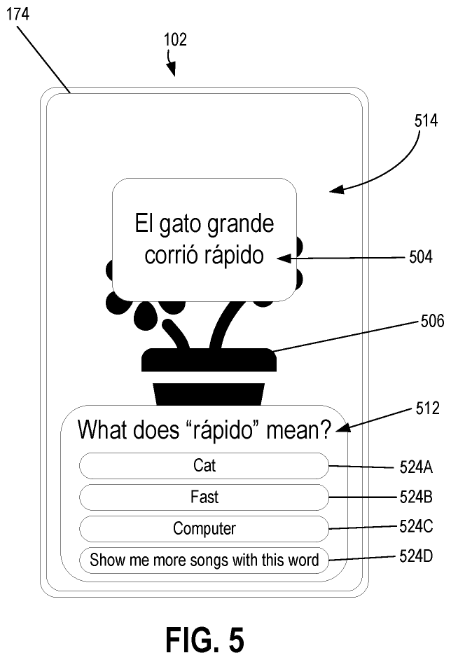

FIG. 5 illustrates a third example of a translation prompt 514 in a multiple-choice style. In the illustrated example, the translation prompt 514 includes a presentation of a lyric 504, a question 512 asking a user to translate a word in the lyric 504, and a plurality of feedback buttons 524. The presentation of the lyric 504 and the question 512 may be similar to the presentation of the lyric 304 and the question 312 in FIG. 3.

In the plurality of feedback buttons 524, there is one feedback button 524B associated with a correct answer to the question 512. At least one of the feedback buttons 524A. 524C is associated with an incorrect answer to the question 512. In the illustrated embodiment, there are two incorrect feedback buttons 524A and 524C. In alternative embodiments, the number of incorrect feedback buttons may be different. Different translation prompts 514 that use this embodiment may present the feedback buttons 524 in a different order such that the feedback button 524B associated with the correct translation is not always the second feedback button 524 from the top.

The translation prompt 514 can be made to be more difficult by changing the translations associated with the incorrect feedback buttons 524A and 524C. For example, the incorrect feedback buttons 524A and 524C could be associated with translations of other words within the lyric 504—like feedback button 524A in the illustrated example being associated with “Cat,” which is a translation of “Gato” in the lyric 504. In another example, the translation prompt 514 could be more difficult if the incorrect feedback buttons 524A and 524C are associated with translations of homophones or homonyms of the word on which the question 512 is based. Similarly, the translations could be homophones or homonyms of the correct translation. In a third example, the incorrect feedback buttons 524A and 524C may be associated with translations of words that were recently used in translation prompts 514 presented to the user.

The translation prompt 514 may also include a feedback button 524D similar to the third feedback button 324C in FIG. 3. In an embodiment, this feedback button 524D may have a different appearance than the feedback button 524B associated with the correct translation and the feedback buttons 524A and 524C associated with incorrect translations. This may distinguish the feedback button 524D from the feedback buttons 524A, 524B, and 524C that are associated with correct or incorrect translations. For example, the feedback button 524D could be a different size, color, or font. In alternative embodiments, the translation prompt 514 does not include a feedback button 524D for finding more media content with the questioned word.

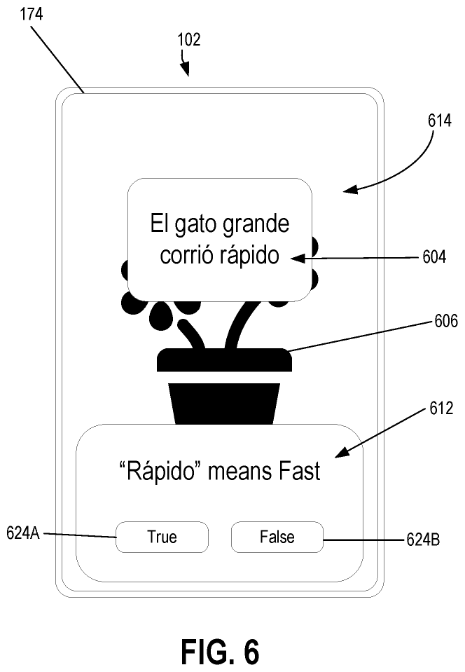

FIG. 6 illustrates a fourth example embodiment of a translation prompt 614 in a true/false style. In this embodiment, the translation prompt 614 includes a presentation of a lyric 604, a question 612, and at least two feedback buttons 624. The presentation of the lyric 604 may be similar to the ones described in relation to FIGS. 3 and 5. The question 612 asks a user if a translation of a word in the lyrics 604 is accurate. In an embodiment, the question 612 is presented as a statement, and the user decides if the statement is true or false. A first feedback button 624A allows the user to indicate that the translation of the word is accurate, and a second feedback button 624B allows the user to indicate that the translation of the word is not accurate. In alternative embodiments, additional feedback buttons may be included. An additional feedback button may be similar to feedback button 324C in FIG. 3.

In alternative embodiments, the presentation of the lyric 604 is similar to the one in FIG. 4, and the question 612 asks the user if a word is the missing word. The translation prompt 614 in such an embodiment still has at least two feedback buttons 624 with one that allows the user to indicate that the word is the missing word and a second that allows the user to indicate that the word is not the missing word.

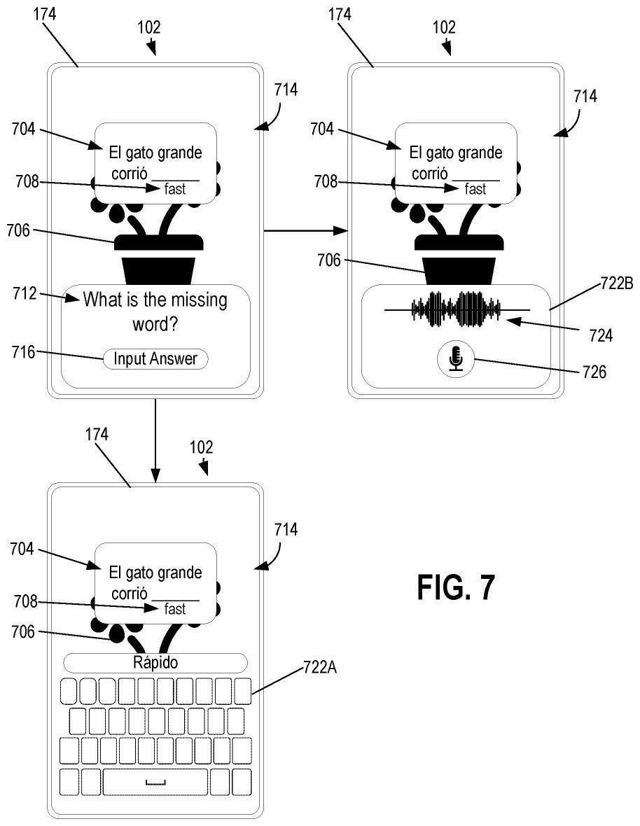

FIG. 7 illustrates a fifth embodiment of a translation prompt 714 in a written or spoken response style. The translation prompt 714 includes a presentation of a lyric 704, a question 712, and an activatable control 716. Like in FIG. 4, the presentation of the lyric 704 includes a missing word and a translation 708 of the missing word. Likewise, the question 712 asks the user to fill in the missing word. When activated, the activatable control 716 opens an input mechanism 722 configured to receive input from the user to answer the question 712. In alternative embodiments, the presentation of the lyric 704 and the question 712 may be similar to in FIG. 3.

Two example input mechanisms 722 are shown in FIG. 7, although an embodiment of the translation prompt 714 may use one or the other. In a first example, the input mechanism 722A may be a keyboard. In an embodiment where the input mechanism 722A is a keyboard, the user may use the input mechanism 722A to type a response to the question 712. The typed response of the user can then be compared to an answer to determine if the user was correct. In performing this comparison, the case of the user response—i.e., whether the user used uppercase or lowercase letters—may be ignored, and the user response may be considered correct even if accent marks were not used. Alternatively, other input mechanisms that allow the user to write a response to the question 712 may be used. For example, if the computing device 102 is a computer, rather than opening a key board for the user, the input mechanism 722A may be a text field in which the user can type an answer using a keyboard of the computer.

In a second example, the input mechanism 722B is an audio recorder. The input mechanism 722B may record a user speaking a response to the question 712. The input mechanism 722B may use the audio input device 170 described in FIG. 2 to record the user response. The spoken response of the user is then compared to an answer to determine if the user was correct. This may be done, for example, by performing a pitch shifting of the media content that the lyric is from to remove sounds other than the missing word being pronounced, such as music. A waveform 724 of the pitch shifted media content, which may be displayed, can then be compared with a waveform of the user response, and if the waveforms are sufficiently similar, it can be inferred that the user response was correct. The input mechanism 722B may include a record button 726. When the user presses the record button 726 a first time, the input mechanism 722B begins to record audio. The next time the user presses the record button 726, the input mechanism 722B stops recording audio.

Although FIGS. 3-7 depict example embodiments of a translation prompt, translation prompts may be presented with additional features not shown in the illustrated examples. For example, a translation prompt may include a button that allows a segment of the media content that contains the lyric to be repeated, potentially at a slower speed. Translation prompts may also include a button that allows the user to save the translation prompt to a list of translation prompts so that the user create custom learning lessons and/or easily find the translation prompt at a later time. The list of saved translation prompts may be saved in a media data store (such as media data store 130 in FIG. 2) or in a user profile database (such as database 154 in FIG. 8). Other features may also be included in translation prompts, whether discussed herein or not.

Referring now to FIG. 8, a schematic block diagram of an embodiment of a language training engine 152 is shown. In the depicted embodiment, the language training engine 152 is shown being external from a computing device 102, and may be part of a media delivery system 104 as is shown in FIG. 2. However, in alternative embodiments, the language training engine 152 may be on the computing device 102, or the computing device 102 may contain components to perform the functions of the language training engine 152 as they are described herein, such as the language trainer 112 in FIGS. 1 and 2.

In the illustrated embodiment, the language training engine 152 includes a personalization system 878 and a translation exercise compiler 886. The language training engine 152 is connected to a computing device 102. The computing device 102 may have similar components to computing device described in FIG. 2. The language training engine 152 may also be connected to a user profile database 154, a lyrics database 156, and a media data store 130. Although not shown, the language training engine 152 may communicate with the other components via a network communication device 162 similar to the one described in FIG. 2.

The functions of the language training engine 152 can be broken down into two categories: compilation of information for translation prompts and media content selection.

### Compilation of Information for Translation Prompts

The language training engine 152 may compile information for translation prompts that are to be presented on the computing device 102. In an embodiment, the language training engine 152 just compiles information used in generating the translation prompts and transmits this information to the computing device 102. In alternative embodiments, the language training engine 152 both compiles the information and uses the information to generate the translation prompts, which the language training engine 152 then transmits to the computing device 102.

A piece of media content may be played on the computing device 102. For example, this piece of media content may be a song. As described above, this song may be streamed from a media delivery system. The song may be selected by a user, or it may be selected by the language training engine 152 as described herein. As the song plays on the computing device 102, the computing device 102 may submit a request to the language training engine 152 for a translation exercise. In this case, the translation exercise may be a translation prompt for the song being played. As mentioned above, in response to the request, the language training engine 152 may return information to the computing device 102 so that the computing device 102 can generate a translation prompt, or the language training engine 152 may generate the translation prompt itself and transmit the translation prompt to the computing device 102.

Upon receipt of the request from the computing device 102, the language training engine 152 may use a personalization system 878 to determine information that can be used to personalize the translation prompt. The personalization system 878 may use a skill level calculator 880 to determine a skill level of the user and a learning need calculator 882 to determine a language learning need of the user. In some cases, the personalization system 878 is bypassed, and the translation prompt generated is not personalized for the user. This may be the case when the user is listening to pre-generated media content and the translation prompts have already been generated or the lyrics for which the translation prompts will be presented have already been determined. As such, the personalization system 878 may be optional in the language training engine 152.

The skill level calculator 880 may determine the skill level of the user. For example, the skill level calculator may classify a user's skill level—such as either beginner, intermediate, or advanced—to match difficulty levels for lyrics in a lyrics database 156, which is described herein. Alternatively, the user's skill level may be a numerical score, rather than a category. In an embodiment, a prompt is displayed to the user on the computing device 102 allowing the user to select his skill level. In alternative embodiments, a test consisting of pre-generated translation prompts is presented to the user on the computing device 102, and the user's skill level is determined by how many of the translation prompts the user answered correctly on the test, with a higher skill level correlating with more correct answers. Either of these embodiments may be used before the user is presented with any personalized translation prompts to determine a baseline skill level for the user. Additionally, in embodiments that use a prompt or a test of translation prompts, the prompt or test may be presented to the user before the song is played on the computing device 102 and the request for a translation exercise is received by the language training engine 152.

In further embodiments, the skill level calculator 880 uses information from a user profile database 154 to calculate the user's skill level. For example, the skill level calculator 880 may access a language learning history 890 within the user profile database 154 to access a history of translation prompts that the user has answered. This history may include whether the user answered each of the translation prompts correctly or incorrectly as well as other information about the translation prompts, such as difficulty. In an embodiment, the user's language learning history 890 may include a list of all translation prompts that the user has answered. In alternative embodiment, only a subset of the translation prompts answered by the user are stored, such as the one hundred most recently answered translation prompts. In further embodiments, rather than storing a list of translation prompts in the user's language learning history 890, statistics on the user's previously answered translation prompts are stored, such as a percentage of translation prompts answered correctly and an average difficulty of the translation prompts presented.

By evaluating this history, the skill level calculator 880 may determine a user's skill level. The percentage of translation prompts answered correctly by the user as well as the difficulty of those translation prompts may affect the user's calculated skill level. For example, the skill level calculator 880 may calculate a higher skill level for a user that answers a high percentage of difficult translation prompts correctly than a user that answers a low percentage of easier translation prompts correctly. The style of translation prompts that the user has answered may also affect the skill level calculation. For example, because translation prompts in a true/false style may be easier than a translation prompt in a written-response style, a correct answer for a written-response translation prompt may be weighted higher than a correct answer for a true/false translation prompt in the skill level calculation.

In situations in which a user has not answered any translation prompts and does not have any data in the user's language learning history 890, the skill level calculator 880 may use a prompt to allow the user to select a skill level or may use a test of translation prompts to determine the user's skill level, as described above. Alternatively, the skill level calculator 880) may assign all users without data in their language learning history 890 a low skill level, such as beginner.

In further embodiments, the skill level calculator 880) may use a combination of the methods described above to calculate a user's skill level. For example, if an evaluation of a user's language learning history 890 had previously determined that the user's skill level was beginner but now determines that his skill level is intermediate, a test of translation prompts may be presented to the user, and the user's skill level may not be determined to be advanced unless the user answers a threshold number of the translation prompts in the test correctly: if the user does not hit that threshold, the user's skill level may be determined to be beginner. The skill level calculator 880 may alternatively or additionally use methods not described herein capable of determining a user's skill level with a language.

The personalization system 878 may also use a learning need calculator 882 to determine a language learning need of the user. For example, the language learning need may be a category or topic of words—e.g., greetings, food items, or weather—for which the user needs more practice. In some examples, the language learning need may be as specific as an individual word. In other examples, the language learning need may be a skill with the language for which the user needs more practice—e.g., reading, listening, speaking, or writing. In some cases, multiple language learning needs may be determined for the user. In those cases, a single language learning need may be selected from the list of language learning needs, a subset may be selected, or all of the determined language learning needs may be used for personalization of translation prompts.

The learning need calculator 882 may use similar methods to determine the user's language learning need as the skill level calculator 880 uses to calculate the user's skill level: a prompt may be presented to the user for him to select a language learning need, a test of translation prompts may be used, and/or the user's language learning history 890 may be evaluated. If a prompt or a test of translation prompts is used to determine both the user's skill level and language learning need, a single prompt or test may be presented to the user from which the skill level and language learning need are both determined rather than presenting separate prompts or tests for determining skill level and language learning need.

When evaluating results of a test or the user's language learning history 890, the learning need calculator 882 may perform more analysis on translation prompts individually. For example, rather than just calculating an overall average for a set of translation prompts, the learning need calculator 882 may look at the style of translation prompt presented (e.g., true/false, written-response, etc.) as well as what topic or category of word was used in the translation prompt.

By analyzing translation prompts for these details, the learning need calculator 882 may determine what the user's language learning needs are. For example, if the learning need calculator 882 determines that a user correctly answers translation prompts about greetings at a lower rate than the user's overall average, the learning need calculator 882 may determine that the user's language learning need is greeting words and phrases. Similarly, if the learning need calculator 882 determines that a user correctly answers written-response translation prompts at a lower rate than the user's overall average, the learning need calculator 882 may determine that the user's language learning need is writing. In alternative embodiments, the learning need calculator 882 may additionally or alternatively compare the user's language learning history 890 to other users' language learning histories—i.e., if the user correctly answers translation prompts about greetings at a lower rate than other users, the learning need calculator 882 may determine that the user's language learning need is greeting words and phrases.

Additionally, the learning need calculator 882 may cooperate with the skill level calculator 880 in determining the user's language learning needs. For example, some language learning needs may be restricted to users at a higher skill level. Topics such as greetings may be selected more for users at a lower skill level whereas medical words and phrases may be selected more for users at a higher skill level. Similarly, a skill that is more basic—such as reading—may be selected more for users at a lower skill level whereas other skills—such as speaking—may be selected more for users at a higher skill level. A user's skill level may also be accounted for in comparing a user's language learning history 890 to the language learning histories of other users. For example, rather than comparing a user's accuracy for translation prompts about greetings to all other users' accuracies with translation prompts about greetings, the learning need calculator 882 may only compare the user against other users at the user's skill level.

Once the personalization system 878 calculates a user's skill level and language learning need, that information is passed to the translation exercise compiler 886. The translation exercise compiler 886 compiles information needed to generate the translation prompt, such as a lyric for which a translation prompt is to be generated as well as a timestamp (or timestamps) of the lyric and its translation.

The translation exercise compiler 886 may receive this information from a lyrics database 156. The lyrics database 156 may contain information about a plurality of songs that are part of a library of songs accessible to the computing device 102. This library of songs may be songs in the media data store 130. In an embodiment, the lyrics database 156 is part of the language training server 150 in the media delivery system 104 shown in FIG. 2. In alternative embodiments, the lyrics database 156 may be remote from the language training server 150 and media delivery system 104. Additionally, in an embodiment, the lyrics database 156 may be connected to other databases and/or services from which the lyrics database 156 receives information. Further, in some embodiments, the lyrics database 156 may be multiple databases rather than a single database. More detail about the lyrics database 156 is provided herein with relation to FIG. 9.

The translation exercise compiler 886 may request from the lyrics database 156 a list of lyrics from the song being played by the user on the computing device 102 that have a translation difficulty that is appropriate for the user's skill level and address a language learning need of the user. For example, if the user's skill level is beginner and the language learning need is greeting words, the lyrics database 156 may return a list of lyrics that include beginner level greeting words. In alternative embodiments, the translation exercise compiler 886 may request an individual lyric that fits the user's skill level and language learning need, rather than a list, and the lyrics database 156 will return an individual appropriate lyric. Similarly, the translation exercise compiler 886 may request a list of lyrics, but the lyrics database 156 may return only a single lyric.

Other criteria may additionally or alternatively be used by the translation exercise compiler 886 in requesting lyrics from the lyrics database 156. For example, if the user is using a learning mode where he practices with a specific segment of a song, the translation exercise compiler 886 may request lyrics just from that segment of the song. The translation exercise compiler 886 may also make requests based on the user's language learning history. As described herein, the translation exercise compiler may request lyrics that were used in translation prompts that the user previously answered.

In alternative embodiments, the translation exercise compiler 886 may only include the user's skill level in the request for lyrics and not the language learning need. For example, if the language learning need of the user is based on a skill, such as writing, rather than selecting a lyric based on that language learning need, that language learning need may instead be reflected in the style of translation prompt—in this case, a written-response style translation prompt would address the user's language learning need of practicing writing.

In some instances, the song for which lyrics are requested may not contain any lyrics that match the user's skill level and language learning need. For example, beginner level greeting words may be requested, but the song may not have any lyrics that are beginner level greeting words. In such a case, the lyrics database 156 may instead return the closest matches to what was requested. In the example given, instead of returning beginner level greeting words, the lyrics database 156 may return intermediate level greeting words. In such a case, to account for the lyric being more difficult, an easier style of translation prompt—e.g., true/false—may be used to reduce the difficulty of the translation prompt. In the example given, the lyrics database 156 may also instead return other beginner level lyrics, even though the returned lyrics are not greeting words.

Along with the lyrics, the lyrics database 156 also returns information about the lyrics to the translation exercise compiler 886. This information may include timestamps of the lyrics and translations of the lyrics. The timestamps may be used to determine a time at which to present a translation prompt: as described above, the translation prompt may be presented at substantially the same time as the lyric is played, and this timing may be based on the timestamps received from the lyrics database 156. This information may also include information needed for different styles of translation prompts, such as incorrect translations for a multiple-choice style translation prompt. In alternative embodiments, additional or alternative information may be included in the response from the lyrics database 156. The lyrics and associated information may then be transmitted to the computing device 102. In an embodiment, the translation exercise compiler 886 may also specify a style of translation prompt to use for a lyric and transmit that information to the computing device 102.

If multiple lyrics are returned from the request to the lyrics database 156, the translation exercise compiler 886 may send information for all of the returned lyrics to the computing device 102 where translation prompts are generated for each of the lyrics. Alternatively, the translation exercise compiler 886 may send information about a subset—which may be just one—of the lyrics returned from the lyrics database 156.

In an embodiment, the translation exercise compiler 886 uses the user's language learning history in the subset selection process, with lyrics that had been used in translation prompts that were previously presented to the user being treated differently depending on whether the user answered the associated translation prompt correctly or incorrectly. For example, the translation exercise compiler 886 may choose a lyric for which the user previously answered a translation prompt incorrectly. The selection may instead be probabilistic: if the user previously answered a translation prompt about the lyric correctly, the translation exercise compiler 886 may be less likely to select this lyric than a lyric for which the user previously got a translation prompt incorrect. A spaced repetition algorithm may be used in this selection process to determine how frequently to repeat translation prompts that the user has already answered. In an alternative embodiment, the spaced repetition algorithm may be incorporated into generating the request from the translation exercise compiler 886 to the lyrics database 156, rather than being used to select lyrics from the list returned by the database lyrics database 156. For example, the translation exercise compiler 886 may use the spaced repetition algorithm to determine about which previously tested lyrics to request information. This may be done in addition to or instead of the previously discussed request process based on the user's skill level and language learning needs.

In alternative embodiments, other methods may be used to select the subset of lyrics for which information is transmitted to the computing device 102. For example, the subset may be selected based on the timestamps of the lyrics, with the subset including lyrics spaced out throughout the song so that the user is not constantly presented with translation prompts. In another example, the subset may be selected randomly. In further embodiments, other methods not herein described may be used to select the subset.

The computing device 102 uses the information it receives from the translation exercise compiler 886 to generate translation prompts. Alternatively, the translation prompts may be generated by the translation exercise compiler 886 and then transmitted to the computing device 102. The translation prompts are then presented to the user as he listens to the song. As mentioned above, the translation prompts may be presented to the user automatically at substantially the same time as the lyric for which the translation prompt was generated is played in the song.

Feedback based on the user's answers to the translation prompts may be transmitted from the computing device 102 to the language training engine 152. For example, the user feedback may include whether the user correctly or incorrectly answered a translation prompt. Alternatively, the feedback may include the user's answer to the translation prompt, and the language training engine 152 determines whether the answer is correct or incorrect.

This feedback may be used, for example, to update the user's language learning history 890 in the user profile database 154 so that future skill level and learning need calculations account for the newly answered translation prompts. Additionally, a user profile stored in the user profile database 154 may be updated. The user profile may include information such as how long the user has been practicing a language and how many words the user has learned. The information in the user profile may be used for leaderboards, allowing a user to compare himself against other users. The user may also be rewarded with gifts or prizes based on the information in his user profile.

Further, the user feedback may be used to update information in the lyrics database 156. For example, if a threshold number of users answer translation prompts about a lyric incorrectly, the difficulty listed for that lyric in the lyrics database 156 may be increased. Similarly, if a threshold number of users answer translation prompts about a lyric correctly, the difficulty may be decreased. In alternative embodiments, rather than transmitting the feedback to the language training engine 152, the computing device 102 may transmit the feedback directly to the user profile database 154 and/or the lyrics database 156 for information to be updated.

### Media Content Selection

In addition to compiling the information for translation prompts for a piece of media content that the user has selected, the language training engine 152 may also select media content for the user. As described herein, this may be done, for example, to create a personalized language training playlist for the user. This may also be done to add media content to a queue to be used in an endless feed. The language training engine 152 may then compile information for translation prompts for the media content that it selected.

Similar to the process described above, the computing device 102 sends a request for a translation exercise to the language training engine 152. The translation exercise may be a song—or multiple songs—with or without translation prompts. Like described above, upon receipt of the request, the personalization system 878 determines the skill level and language learning needs of the user. This may be done by a skill level calculator 880 and learning need calculator 882 in a way similar to what was described above.

Additionally, the personalization system 878 may use a music taste calculator 884 to determine a music taste of the user. The music taste calculator 884 may determine a single music taste for the user or multiple. In an example, music tastes may be lists of media content, potentially with similar characteristics. In a second example, music tastes may be identifiers where each identifier can be used to find pieces of media content that have similar features. Using music tastes, media content may be found that the user is expected to like. Although described as determining a “music” taste, the music taste calculator 884 be used to determine a user's preferences for other forms of media content.

The music taste calculator 884 may use data about the user stored in a user listening history 888 in the user profile database 154. In alternative embodiments, the user listening history 888 may be stored in a different database, or it may be stored across multiple databases. In an embodiment, the user listening history 888 contains a list of media content to which the user has listened. In some embodiments, the user listening history 888 contains a list of all media content to which the user has listened from a media delivery system. In alternative embodiments, the user listening history 888 contains only a subset of that media content—for example, the one hundred most recent pieces of media content.

In an embodiment, the music taste calculator 884 evaluates the list of media content in the user's listening history 888 to extract features of the media content that are used to determine a music taste of the user. For example, the list of media content may be a list of songs to which the user has listened. In this example, the music taste calculator 884 may extract features from the songs such as genre, tempo, and key. In other examples, additional or alternative features may be extracted.

The features from the extracted songs may then be averaged and then compared against other songs. If a song has features that are similar to the average features of the songs from the user's listening history, the song may be added to a list of songs to be used as the user's music taste. Alternatively, a vector of the averaged features may be used as the user's music taste. Further, the average of the features may be used to classify the user and assign the user music taste identifier that can be used to find songs of that music taste. If the user listens to multiple types of music, the features may instead be assigned to clusters of songs with similar features, and averages may be taken from within each cluster to find music tastes of the user.

In an alternative embodiment, the music taste calculator 884 uses the user's most recently listened to media content in the user listening history 888 as the music taste. For example, the music taste calculator 884 may create a list of the one hundred pieces of media content that the user has listened to most recently and uses this list as the music taste without evaluating any features of the media content. In further embodiments, other methods of determining a music taste for the user may be performed by the music taste calculator 884.

The music taste may then be passed along with a calculated skill level and language learning need from the personalization system 878 to the translation exercise compiler 886. The translation exercise compiler 886 may use that information to find media content that is appropriate for the user. The translation exercise compiler 886 may request from the lyrics database 156 a list of media content in the target language of the user that matches the music taste of the user and has a lyric that addresses the language learning need of the user and has a translation difficulty that matches the skill level of the user.

If the user's music taste is a list of media content, the lyrics database 156 may determine which of the pieces of media content in that list have a lyric that is appropriate for the user's skill level and language learning need and return a filtered list of the relevant pieces of media content to the translation exercise compiler 886. If the user's music taste is an identifier, the lyrics database 156 may use that identifier to find pieces of media content associated with the identifier, determine which of the pieces of media content associated with the identifier include a lyric that is appropriate for the user's skill level and language learning need, and return a filtered list of the relevant pieces of media content to the translation exercise compiler 886. If the user's music taste is a vector of features, the lyrics database 156 may find pieces of media content that have features similar to the vector of features and include a lyric that is appropriate for the user's skill level and language learning need, and return those selected pieces of media content.

If the lyrics database 156 is unable to find a piece of media content that matches the user's music taste and has a lyric that is appropriate for the user's skill level and language learning need, the lyrics database 156 may return a list of the pieces of media content that were the closest matches. For example, the lyrics database 156 may return media content that matches the user's music taste and has a lyric that addresses the user's language learning need, but the lyric is not at the skill level of the user. Similarly, the lyrics database 156 may return media content that matches the user's music taste and has a lyric that is at the user's skill level, but the lyric does not address the user's language learning need. In another example, it may return media content that has a lyric that is appropriate for the user's skill level and language learning need, but the media content does not match the user's music taste.

The translation exercise compiler 886 may return the selected media content to the computing device 102, and the computing device 102 may play the media content for the user. The computing device 102 may stream the selected media content. In an embodiment, before transmitting the media content to the computing device 102, the translation exercise compiler 886 compiles information for translation prompts for the pieces of media content. This may be done in a manner similar to what has been described above. In an alternative embodiment, the translation exercise compiler 886 just sends the selected media content, and the information for a translation prompt for a piece of media content is not compiled until that media content is played on the computing device 102.

Additionally or alternatively, the translation exercise compiler 886 may organize the media content as a playlist, which it transmits to a media data store 130 for the playlist to be stored. This allows the user to access the selected media content at a later time. The translation exercise compiler 886 may also or alternatively add the returned media content to a queue used in the endless feed learning mode.

FIG. 9 illustrates an example embodiment of the lyrics database 156. As described above, the lyrics database 156 includes information about media content that can be used to create translation prompts. The media content on which the database 156 has information may be media content that is accessible to a computing device that can play media content for a user. In the illustrated embodiment, the lyrics database 156 includes data records for pieces of media content in the form of tables 902. Each table 902 has a plurality of columns 904-922 that include information about the media content and/or its lyrics. Each row in the table 902 is for a different lyric in the media content. Although tables 902 are used in the illustrated embodiment, many other possible database or data storage formats can also be used (e.g., lists, inverted indexes, relational database, linked lists, graph database, etc.).

The table 902A in the illustrated embodiment includes information about a song. In other embodiments, the table 902A may include information about other forms of media content. The table 902A may include additional or alternative information when the media content is of a form other than a song.

A lyric language column 904 may include information about the language of the lyrics of the media content. In the illustrated embodiment, the media content has lyrics in Spanish. Although the example media content shows each lyric being in the same language, other pieces of media content may have lyrics in multiple languages.

A prompt language column 906 may include information about the language in which a translation prompt is to be presented for the lyric. When information is being pulled from the table 902A for use in translation prompts, the information may be pulled from rows of the table 902A that have a prompt language that matches a language that the user can understand. In the illustrated example, information from the rows of the table 902A may be used to generate translation prompts for a user who is learning Spanish and already understands English. Each lyric in the media content may be associated with multiple rows in the table 902A, with each row for the lyric being for a different prompt language, allowing one piece of media content to be used for users who understand different languages.

A difficulty column 908 may include information about a translation difficulty for the lyrics of the prompt words column 920. Information in the difficulty column 908 may be used to find lyrics that match a skill level of a user when personalizing translation prompts for the user.

In the illustrated embodiment, the difficulties are classifiers such as beginner and intermediate. Lyrics may be assigned to other difficulty classifiers that are not shown in the illustrated table 902A, such as advanced. In alternative embodiments, difficulty may be measured in alternative manners, such as a difficulty score, where a higher difficulty score is correlated with a more difficult lyric. In further embodiments, other methods of measuring difficulty may be used.

Difficulty may be computed manually for each lyric. Alternatively, difficulty may be computed automatically. For example, the difficulty for a lyric may be computed by scanning a corpus of works in the language of the lyric to determine the frequency of use of the lyric in the language. A lyric may be assigned a higher difficulty if the lyric is used less frequently and a lower difficulty if the lyric is used more frequently.

Additionally, difficulties may be automatically updated as users answer translation prompts about the lyric. As described above, if users frequently answer translation prompts for a lyric incorrectly, the difficulty for that lyric may be increased. Similarly, if users frequently answer translation prompts for a lyric correctly, the difficulty for that lyric may be decreased.

A topic column 910 may include information about the topic or category of the word of the lyric. Information in the topic column 910 may be used to find lyrics that are associated with a language learning need of the user when personalizing translation prompts for the user. Although the illustrated embodiment shows each lyric having a single topic in the topic column 910, lyrics may be associated with multiple topics.

A media content uniform resource identifier (URI) column 912 may include a URI for the media content about which the table 902A contains information. The URI may reference the entire piece of media content, or it may be linked to a specific segment of the media content. The URI may be used to find tables 902 for specific pieces of media content within the lyrics database 156. The URI may also be used to when a language training engine transmits a media content selection to a computing device, as described above. This allows the computing device to find and play the media content. For example, the URI could be used to find a piece of media content to be streamed from a media server to the computing device.

A synced words column 914 may include a lyrical phrase from the media content. Although the examples in the illustrated embodiment are each multiple words, the lyrical phrases in the synced words column 914 may be a single word. Multiple rows may contain the same lyrical phrase because multiple words or phrases from within the lyrical phrase may be selected as potential prompt words, as seen in the prompt words column 920.

A start time column 916 and an end time column 918 may contain timestamps for the start time and the end time of the lyrical phrase in the synced words column 914. The timestamps may be in any unit of time measurement, such as milliseconds. As described above, these timestamps may be used to determine a time at which to present a translation prompt for the prompt words in the prompt words column 920. In alternative embodiments, the start time column 916 and end time column 918 contain timestamps for the start time and the end time of the prompt words in the prompt words column 920, rather than the timestamps for the lyrical phrases in the synced words column 914. In alternative embodiments, rather than having an end time column 918, a duration column with information about the duration of the lyrical phrase in the synced words column 914 may be used.

A prompt words column 920 contains the lyric from the media content that is to be tested in translation prompts. The lyric may be a single word from the lyrical phrase in the synced words column 914, or the lyric may be multiple words from the lyrical phrase. As previously mentioned, the difficulty in the difficulty column 908 and the topics/categories in the topic column 910 may be for the lyric in the prompt words column 920.

A translated words column 922 contains a translation of the lyric in the prompt words column 920. The translation may be used as an answer to a translation prompt created using the lyric in the prompt words column 920. The translated words column 922 may include a single translation, like the first row of the table 902A that gives a single translation (“dog”) for the prompt word (“perro”). The translated words column 922 may also contain multiple possible translations, like the second row of the table 902A that gives two translations (“smart” and “intelligent”) for the prompt word (“inteligente”).

Having multiple possible translations enables more answers in translation prompts to be considered correct. This is particularly relevant for translation prompts in a style that accepts a written or spoken response from the user as an answer, such as the example embodiment shown in FIG. 7. Because a translation may have multiple synonyms that are also accurate translations of the lyric, including more translations in the translated words column 922 means that more responses from the user can be considered correct.

Translations for the translated words column 922 may be determined manually. For example, translations may be provided by the creator of the media content. Alternatively, translations may be made automatically by using machine translations of the lyrics. Using machine translations quickens a set-up process for the lyrics database 156 and makes it easier for a large amount of media content to be translated: however, the machine translations may not be as accurate as manual translations, and fewer possible translations may be considered.

In alternative embodiments, each table 902A may include additional or alternative columns for other information about the media content. For example, the table 902A may include a column for a music taste identifier, allowing the media content to be associated with a music taste as described above. The table 902A may also include columns for information about features of the media content-such as genre, tempo, and key-so that media content that matches a user's music taste to be identified by those features. The table 902A may also include a column that includes possible incorrect choices for a translation prompt that is presented in a multiple-choice style, such as the example embodiment of FIG. 5.

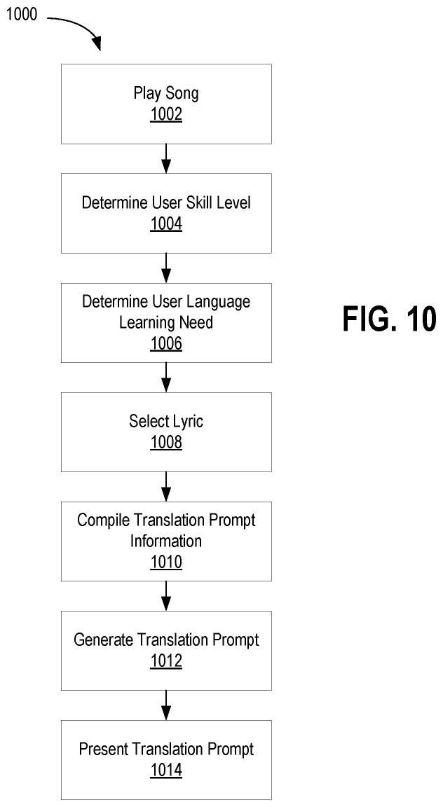

Turning to FIG. 10, a flowchart illustrating an example method 1000 of presenting translation prompts is presented. In this example, the method 1000 includes operations 1002. 1004, 1006, 1008, 1010, 1012, and 1014. This method 1000 may be performed, for example, by a system like the one described in FIG. 2 with a computing device 102 and a media delivery system 104. The media delivery system 104 may include a language training engine 152, such as the one described in FIG. 8. In other examples, the method 1000 may be performed solely on a computing device 102 with a language trainer 112 as described in FIG. 2. In further examples, the method 1000 may be performed by other hardware suited for performing the operations as described herein.

Operation 1002 is performed to play a song for a user. In alternative examples, other forms of media content may be played for the user, such as a podcast, an audiobook, or an advertisement. Further, a segment of a song—or other media content—may be played rather than a whole song. The song may be played on the computing device using a media-play back engine, and the song may be streamed from a media server within the media delivery system. As described above, the song may be a song of the user's choice, or it may be selected for the user based on the user's skill level, language learning needs, and music taste.

Operations 1004 and 1006 are performed to generate information to personalize the translation prompt for the user. In some embodiments, operations 1004 and 1006 may be optional, and translation prompts may be generated for the user that are not personalized. In other embodiments, a subset of operations 1004 and 1006 may be performed such that there is still some personalization of the translation prompt.

A user's skill level is determined when operation 1004 is performed. In an example, the user's skill level is determined by evaluating a language learning history of the user. Translation prompts that the user has previously answered are evaluated to determine the difficulty of those translation prompts as well as whether the user answered them correctly. Depending on the amount that the user got correct and the difficulty of the translation prompts, a skill level can be determined for the user. In another example, the user's skill level may be determined by presenting the user with a prompt that allows the user to select a skill level for himself. In a further example, a test of translation prompts can be presented to the user, and the user's results on the test are used to determine the user's skill level. It is possible for multiple calculation methods to be used as well (e.g., a test of translation prompts is presented to the user and the user's language learning history is evaluated).

As described above, a skill level calculator may be used to determine the user's skill level. The skill level calculator may be part of a personalization system within the language training engine. The skill level calculator may retrieve information about the user's language learning history from a user profile database and use that information in calculating the skill level as previously described. The skill level calculator may also cooperate with the computing device in determining the user's skill level. For example, the prompt that allows the user to select a skill level for himself or the test of translation prompts may be presented to the user at the computing device.

At operation 1006, at least one language learning need is determined for the user. For example, the user's language learning need may be a category or topic of words with which the user needs the user needs more practice. The user's language learning need may also be a specific word or phrase with which the user needs more practice. In another example, the user's language learning need could be a skill that the user needs to practice, such as reading, listening, speaking, or writing.

The user's language learning need may be determined using similar methods to what was previously discussed for determining the user's skill level: a user's language learning history may be evaluated, a prompt may be presented to the user to select a language learning need, and/or a test of translation prompts may be presented to the user.

As described above, when evaluating translation prompts previously answered by the user-either through the user's language learning history or from the test of translation prompts-to determine a language learning need, a style of the translation prompt (i.e. written-response) and a topic of a lyric in the translation prompt may be considered in the language learning need calculation. For example, if the user incorrectly answers translation prompts of a certain style or about lyrics of a certain topic more frequently than other users, it may be determined that the user has a language learning need in that area.

A user's skill level may also be considered in determining the user's language learning need. For example, some skills (e.g., speaking) or topics (e.g., medical words) may be restricted to users at a higher skill level while other skills (e.g., reading) or topics (e.g., greetings) may be used for users at a lower skill level. Additionally, when comparing a user against other users to determine if he answers translation prompts of a certain topic or style incorrectly more frequently than the other users, the user may only be compared to other users at the same skill level as the user.

Operation 1006 may be performed by a learning need calculator. The learning need calculator may be part of a personalization system within a language training engine. The learning need calculator may use information stored in a user profile database about the user's language learning history in its calculation of the user's language learning need. Additionally, the learning need calculator may cooperate with a computing device to, for example, present a prompt to the user to select his language learning need. The learning need calculator may further cooperate with a skill level calculator when a user's skill level is considered in the learning need calculation.

A lyric for which a translation prompt is to be displayed to a user is selected during operation 1008. Lyrics of the song that is played at operation 1002 are evaluated to determine which of the lyrics are appropriate for translation prompts for the user. The song may have a plurality of lyrics from which to select.

The lyric that is selected may be based, at least in part, on the user's skill level determined with operation 1004. The selected lyric may have a translation difficulty that matches the skill level of the user. For example, if the user's skill level is beginner, a lyric may be selected that has a translation difficult of beginner.

In some examples, a translation difficulty may be a numerical score, not a category like beginner, so the lyric may be selected if the translation difficulty score is within a range that is appropriate for the user's skill level (e.g., if translation difficulty scores range from zero to one hundred, the selected lyric may have a translation difficulty score between zero and thirty if the user's skill level is beginner). Conversely, the translation difficulty may be category and the user's skill level may be a numerical score. In such a case, the lyric may be selected if the user's skill level is within a range for the lyrics category (e.g., if user skill levels range from zero to one hundred, the selected lyric may have a translation difficulty categorized as beginner if the user's skill level is between zero and thirty).

In other examples, both the translation difficulty and the user's skill level may be a numerical score. In such a case, the lyric may be selected if the translation difficulty is within an acceptable range of the user's skill level. For example, if both the user's skill level and the lyric's translation difficulty are scored between zero and one hundred, an acceptable range may be fifteen points (i.e., if the user's skill level is twenty, a lyric with a translation difficulty between five and thirty-five may be appropriate).

In further examples, whether the lyric's translation difficulty is appropriate for the user's skill level may be determined in other manners as applicable based on the way that the user's skill level and the lyric's translation difficulties are measured.

In cases in which there are no lyrics that have a translation difficulty that is appropriate for the user's skill level, a lyric may be based on other criteria herein described. Additionally or alternatively, a lyric may be selected that is close to being appropriate for the user. For example, if the user's skill level is beginner, a lyric with an intermediate translation difficulty may be selected. If a lyric is selected that has a translation difficulty that is not appropriate for the user's skill level, a style of translation prompt may be used to account for this difficulty. If the translation difficulty is higher than what would be appropriate for the user's skill level, the translation prompt may be presented in a style that presents an easier question, such as a true/false style. If the translation difficulty is lower than what would be appropriate for the user's skill level, the translation prompt may be presented in a style that presents a more difficult question, such as a written-response style.

The lyric may also be selected based, at least in part, on the user's language learning need determined with operation 1006. The lyric may be selected if it is associated with the user's language learning need. For example, if the user's language learning need is a topic or category of word with which the user needs more practice, the selected lyric may be a word or phrase of that topic or category (e.g., if the user's language learning need is greeting words, the selected lyric may be a greeting word or phrase).

If no lyric in the song is associated with a language learning need of the user, the lyric may be selected based on other criteria herein described. Additionally or alternatively, a lyric may be selected that addresses a language learning need that is similar or related to the language learning need of the user. For example, if the user's language learning need is greeting words and phrases, and the song has no lyrics that include greeting words, a lyric may be selected that has farewell words.

In some embodiments, the user's language learning need may not be considered during lyric selection and may instead be considered when information for the translation prompt is being compiled in operation 1010. As described herein, the user's language learning need may be considered during operation 1010 to determine what style of translation prompt should be presented to the user.

The lyric may further be selected based, at least in part, on the user's language learning history. Lyrics that were used in translation prompts that the user answered incorrectly may be more likely to be selected than lyrics that were used in translation prompts that the user answered correctly. This helps improve the learning of the user by giving him more practice with lyrics with which he has previously struggled while still allowing for lyrics that the user has previously translated correctly to be shown occasionally to solidify those lyrics in the user's memory. A spaced repetition algorithm may be used to determine which lyrics to reuse from previously answered translation prompts and how often to repeat them.

In some embodiments, the lyrics selected may be based solely on the user's language learning history and not the user's skill level or language learning need. This may be done to allow lyrics that are not appropriate for the user's skill level and language learning need to be presented in translation prompts so that the user continues to benefit from the spaced repetition. For example, the user may advance from one skill level to a more advanced skill level. This would prevent the user from seeing translation prompts on lyrics that were previously presented to the user because the previously presented lyrics were personalized to be at the user's previous skill level. In alternative embodiments, the user's language learning history is not considered in the selection of lyrics.

The learning mode could also be used in the lyric selection process. For example, if the user is progressing through a single song to eventually learn the entire song, the selection of the lyric may be based, at least in part, on a timestamp of the lyric: the lyric will be selected from a segment of the song that the user is currently practicing. Additionally, if the user is practicing with an endless feed of songs, the lyric may be selected from a memorable part of the song (e.g., the chorus or the hook) so that the user may have a favorable impression of that song, especially if only a segment of the song including the lyric is used in the endless feed and the song was selected for the user.

The song from which the lyric is being selected may have multiple lyrics that match the specified criteria. In such a case, all of the lyrics that match the criteria may be selected to be used in translation prompts. Alternatively, a subset of the lyrics—which could be just one lyric—is selected to be used in translation prompts. The subset may be selected using one of the criteria discussed above if that criterion was not considered in the initial filtering of lyrics. The subset may also be selected based on the timestamps of the lyrics. This could create a subset that includes lyrics that are spaced out through the song to prevent the user from being overwhelmed with translation prompts. Random selection may also be used to select the subset of lyrics. Other methods may be used to select the subset of lyrics as applicable.

A translation exercise compiler and a lyrics database may be used to perform operation 1008. The translation exercise compiler may receive information about the user, such as the user's skill level and language learning need, from a personalization system. The translation exercise compiler may receive other information, such as the user's language learning history from other component, such as a user profile database. The translation exercise compiler may use that information to request lyrics from the lyrics database that are appropriate for the user. The lyrics database may be configured similarly to the lyrics database 156 in FIG. 9. The lyrics database may return a lyric—or a list of lyrics—to the translation exercise compiler. If a list of lyrics is returned, the translation exercise compiler may filter the list to create a subset of lyrics for which translation prompts will be generated.

Operation 1010 is performed to compile information about the lyric for a translation prompt about the lyric. The lyric may be the lyric selected in operation 1008. Information compiled about the lyric may include a timestamp (or timestamps) of the lyric in the song and a translation of the lyric. If multiple lyrics were selected in operation 1008, information about the multiple lyrics may be compiled in operation 1010.

Additionally, information about what style of translation prompt in which the lyric will be presented may be compiled in this operation 1010. As described above, the style of translation prompt may be selected based on a language learning need of the user. For example, if the user needs to practice speaking the language, the translation prompt may be presented in a spoken-response style. The style of translation prompt may also be selected to account for a translation difficulty of the lyric that does not match the skill level of the user. For example, if the translation difficulty of the lyric is higher than the skill level of the user, the translation prompt may be presented in an easier style, such as true/false or multiple choice. Further, the style of translation prompt may be selected based on the user's language learning history. If the lyric was selected based on the user's language learning history, as described above in operation 1008, the style of translation prompt may be the same as the style of translation prompt presented when the lyric was previously tested.

If the style of translation prompt is one that includes incorrect translations of the lyric, such as a multiple-choice style, information for the incorrect translations may be compiled during this operation 1010 as well. As previously discussed, incorrect translations may be chosen that are homophones or homonyms of the lyric or the translation of the lyric.

Like with operation 1008, a translation exercise compiler and a lyrics database may be used to perform operation 1010. The translation exercise compiler may request information about the lyric, such as a translation and timestamp, from the lyrics database. The lyrics database may return that information to the translation exercise compiler.

The translation exercise compiler may also compile information about the style of translation prompt in which the lyric will be tested. This information may be computed by the translation exercise compiler. For example, the translation exercise compiler may compare the translation difficulty of the lyric to the user's skill level and may determine that a certain style of translation prompt should be presented to account for a discrepancy between the translation difficulty and the user's skill level. The translation exercise compiler may also receive information from other components to determine the style of translation prompt. For example, if the lyric is selected from a user's language learning history using a spaced repetition algorithm, the translation exercise compiler may also reference the user's language learning history to determine what style of translation prompt to present.

Depending on the style of translation prompt, the translation exercise compiler may compile additional information for incorrect translations. This may be done, for example, if the translation prompt is a multiple-choice style. The information about incorrect translations may come from the lyrics database. Alternatively, the incorrect translations may come from another component.

The translation prompt is generated during operation 1012 and then presented to the user during operation 1014. The translation prompt may be generated using the information compiled during operation 1010. The translation prompt may be generated into one of the example styles as depicted in FIGS. 3-7, or it may be generated with a different appearance.

When the translation prompt is presented to the user during operation 1014, it may be presented visually, allowing the user to read a question about translating the lyric. Additionally or alternatively, the translation prompt may be presented auditorily, allowing the user to hear the question about the lyric. After the translation prompt is presented, the user may interact with the translation prompt to provide feedback about whether the user answered the question correctly or incorrectly.

The translation prompt may be presented at substantially the same time as the lyric is played. This allows the user to hear the lyric for which the translation prompt is being presented while the translation prompt is being displayed. The time at which the translation prompt is displayed may be based on the timestamps determined during operation 1010. For example, the translation prompt may be presented at a time between a start time and an end time for the lyric, as determined by the timestamps. Alternatively, the translation prompt may be presented shortly after the lyric is played—e.g., within a second-allowing the user to focus on listening to the lyric before contemplating a question in the translation prompt. In further examples, the translation prompt may be presented shortly before the lyric is played—e.g., within a second.

The translation prompt may also be presented automatically without input from the user while the lyric is playing. Because the translation prompt may be personalized using the user's skill level and language learning need determined in operations 1004 and 1006, the user need not select a lyric to get a translation prompt for that lyric: the lyric is already selected for the user during operation 1008, so no input from the user is needed to get the translation prompt presented.

In an example, the translation prompt is generated during operation 1012 by a computing device, such as computing device 102 in FIG. 2. In that example, the lyric information compiled during operation 1010 may be transmitted from a device that did the compiling, such as a translation exercise compiler in a language training engine, to the computing device. The computing device can then present the translation prompt. The translation prompt may be presented visually on a visual output device of the computing device, and it may be presented auditorily through an audio output device of the computing device. In another example, the translation prompt may be generated by the translation exercise compiler, and the generated translation prompt is then transmitted to the computing device to be presented to the user.

In some embodiments, translation prompts may be presented to the user without performing all of the operations in method 1000. For example, if the user chooses to engage with a pre-generated language training exercise, translation prompts may have already been generated for the exercise. In such a case, the translation prompt may be displayed just by playing a song from the pre-generated exercise with operation 1002 and then presenting the translation prompt with operation 1014. Alternatively, information for the translation prompt may already be compiled in the pre-generated exercise, but the translation prompt is not pre-generated, so operation 1012 may need to be performed as well. In other examples, translation prompts may be displayed to the user with different subsets of the operations being performed. In further examples, additional or alternative operations may be performed in displaying a translation prompt to a user.

In other embodiments, the operations shown in the example method 1000 may be performed in a different order than as described above. For example, if the user's skill level or language learning need is to be determined by a test of translation prompts or a prompt where the user can select their skill level/language learning need, that may be done before a song is played during operation 1002.

In another example, there may be situations in which the song that is played during operation 1002 is selected for the user based, at least in part, on the user's skill level and language learning needs. Because the selection of the song at least partially depends on the user's skill level and language learning needs, the user's skill level and language learning needs must be determined early in the method 1000 so that the song can be selected and then played.

In further embodiments, some of the operations shown in the example method 1000 may be performed concurrently. For example, the user's skill level and language learning need may be determined at the same time, rather than determine the skill level first and then determining the user's language learning needs. In another example, lyric information may be compiled (operation 1010) concurrently with the lyric being selected (operation 1008). This is most beneficial in cases where operations 1008 and 1010 are both performed by a translation exercise compiler and a lyrics database as described above. Rather than the translation exercise compiler first requesting an appropriate lyric—or a list of appropriate lyrics—from the lyrics database and then making a subsequent request to the lyrics database information about the lyric returned from the lyrics database, the lyrics database may return the information about the lyric in the response to the initial request for lyrics.

In other examples, aspects of an operation that have been described above may be performed during a different operation. For example, if both the user's skill level and language learning need are determined by presenting a test of translation prompts to the user, a single test may be presented to the user and the user's skill level and language learning need may be calculated using the results of that single test: it may be unnecessary to present a first test during operation 1004 to determine the user's skill level and then presenting a second test during operation 1006 to determine the user's language learning need.

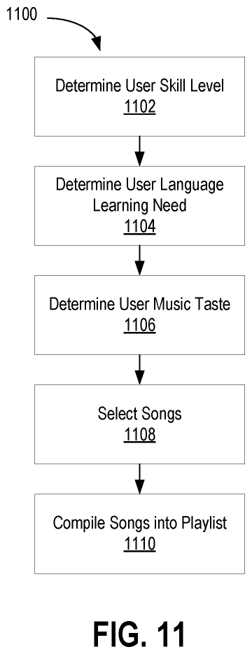

FIG. 11 illustrates an example flowchart of a method 1100 for compiling personalized language training playlists for a user. The method 1100 may include operations 1102, 1104, 1106, 1108, and 1110. This method 1100 may be performed, for example, by a media delivery system 104 like the one described in relation to FIG. 2. The media delivery system 104 may include a language training engine 152, such as the one described in FIG. 8. In other examples, the method 1100 may be performed by the media delivery system in coordination with a computing device (e.g., the computing device 102 in FIG. 2), or the method 1100 may be performed solely on the computing device 102. In further examples, the method 1100 may be performed by other hardware suited for performing the operations as described herein.

Although example method 1100 describes compiling playlists of songs for a user, other forms of media content may similarly be compiled into a playlist using the operations described in method 1100.

Operations 1102 and 1104 are performed to determine a user's skill level and language learning need. These operations 1102 and 1104 may be performed in a manner similar to operations 1104 and 1106 of method 1000 described in relation to FIG. 10 above. As discussed above, these operations 1102 and 1104 may be performed by a skill level calculator and a learning need calculator of a personalization system in a language training engine operating within a media delivery system. A computing device may also be involved in operations 1102 and 1104 if the skill level and/or language learning need are determined using a test of translation prompts or a prompt that allows the user to select his skill level and/or language learning need. A user profile database may also be involved in operations 1102 and 1104 if the skill level and/or language learning need are determined by evaluating a user's language learning history.

Operation 1106 is performed to determine a music taste of the user. As described above, the music taste may be in the form of a list of songs with similar characteristics. The music taste may also be an identifier that can be used to find songs with similar characteristics or a vector of features to compare against songs. The music taste may be used to find songs that the user is expected to like.

The user's music taste may be determined by evaluating data about the user's listening history. Songs in the user's listening history may be evaluated to extract features about the songs, such as genre, tempo, and key. All songs in the user's listening history may be evaluated, or only a subset of the songs may be evaluated, such as the one hundred songs to which the user has listened most recently. The values for the extracted features may then be averaged to determine the user's music taste. If the user listens to multiple types of music, the evaluated songs may be clustered with other evaluated songs that have similar features, and then an average for each feature may be taken within each cluster, so multiple music tastes may be determined for the user. Using these features, a music taste identifier may be assigned as the user's music taste. Alternatively, the vector of features may be used as the user's music taste.

Alternatively, the songs in the user's listening history may be used as the user's music taste. Like when extracting features from songs, the entirety of the user's listening history may be used or just a subset of it. In further embodiments, other methods may be used to determine a user's music taste.

Songs may be selected based on the determined skill level, language learning need, and/or music taste during operation 1108. These songs may be in a target language of the user. As described above, if a song is selected based on the user's skill level, the song may contain a lyric that has a translation difficulty that matches the user's skill level. Similarly, if a song is selected based on the user's language learning need, the song may contain a lyric that addresses the user's language learning need.

How songs are selected based on a user's music taste may depend on how the music taste is determined. If the user's music taste is a list of songs (e.g., the one hundred songs to which the user has listened most recently), then a song may match the user's music taste if it is included in the list of songs. If the user's music taste is an identifier, then songs that are associated with that identifier may be selected. If the user's music taste is a vector of features, then the vector of features for the user's music taste may be compared to vectors of features for songs, and songs that have features that are similar to the feature vector for the user's music taste may be selected.

The selected songs may meet requirements for all of the user's skill level, language learning need, and music taste. Alternatively, the songs may be selected based on a subset of those criteria. It some cases, not all of the selected songs are selected based on the same criteria. For example, there may be some songs that are selected based on the user's skill level and music taste while other songs are selected based on all of the user's skill level, language learning need, and music taste.

Operation 1108 may be performed by a translation exercise compiler and a lyrics database. The translation exercise compiler may receive the user's skill level, language learning need, and music taste determined in operations 1102, 1104, and 1106 and use that information to select songs from the database. The database may contain information about a plurality of songs in a library of songs that is accessible to a computing device of the user. The translation exercise compiler may request songs from the database that are appropriate for the user based on the user's skill level, language learning need, and music taste, and the database may return a song—or list of songs—that meet those criteria.

The songs selected during operation 1108 may be compiled into a playlist during operation 1110. The selected songs may be linked into a sequential list and stored in a manner that allows the user to repeatedly access the playlist and play the songs saved in the playlist.

Operation 1110 may be performed by a translation exercise compiler cooperating with a media data store. In an embodiment, the translation exercise compiler may link the songs and store the linked list of the songs in the media data store as a playlist. Alternatively, the translation exercise compiler may just transmit the songs—or an identifier of each of the songs—to the media data store where the media data store compiles the songs into a playlist and stores the playlist.

In alternative embodiments, operation 1110 can be performed to use the songs selected in operation 1108 in different ways. For example, if the user is practicing in the endless feed learning mode, the songs may be added to a queue for the endless feed rather than being compiled into a playlist. Additionally, if the method 1100 is used for selecting songs for an endless feed, the method 1100 may be repeated endlessly so that the queue of songs for the endless feed does not empty. In another example, the songs may be transmitted to a computing device of the user to be played.

The operations of method 1100 may be performed in a different order than that shown in FIG. 11. For example, operation 1106 to determine the user's music taste may be performed before the user's language learning need is determined with operation 1104. Similarly, some operations in method 1100 may be performed concurrently. For example, operations 1102, 1104, and 1106 may all be performed concurrently. Further, additional operations not shown in FIG. 11 may be performed during the method 1100. It may be advantageous to compile information for translation prompts for lyrics in the songs selected during operation 1108. Because the selection of songs during operation 1108 may be based, at least in part, on the songs having a lyric that matches user's skill level and language learning need, information for a translation prompt for that lyric—and potentially for other appropriate lyrics—may be compiled during the method 1100 while that lyric is being evaluated. This may improve efficiency later on when the user listens to the selected song and a translation prompt must be generated to present to the user.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of teaching a user a language using media content, the method comprising:
playing, on a computing device, at least a segment of a song, the segment having a lyric:
determining a time at which the lyric will be played; and
presenting, at the computing device, a translation prompt for the lyric at a time that is substantially the same as the time at which the lyric is played,
wherein the translation prompt is automatically presented without an input from the user at a time during which the segment is playing.

2. The method of claim 1, further comprising:
determining a skill level of the user:
determining a language learning need of the user; and
selecting the lyric from a plurality of lyrics of the segment based, at least in part, on the skill level and language learning need of the user.

3. The method of claim 2, wherein selecting the lyric from the segment is further based, at least in part, on a language learning history for the user, wherein the lyric is selected from a translation prompt in the language learning history which the user had previously answered.

4. The method of claim 1, wherein the song is selected from a playlist of songs, the playlist of songs generated by:
determining a language learning need for a language for the user:
determining a skill level of the user:
determining a music taste of the user:
selecting a plurality of songs, each song in the plurality of songs matching the user's music taste and having a lyric, wherein the lyric is associated with the language learning need and has a translation difficulty that substantially matches the user's skill level; and
assembling the plurality of songs into a playlist, wherein the playlist is playable on the computing device.

5. The method of claim 1, wherein the translation prompt is presented visually on a visual output device of the computing device.

6. The method of claim 1, wherein the translation prompt further comprises:
a first flashcard user interface presenting a question, the question asking the user to translate a word in the lyric;
a second flashcard user interface presenting a translation of the word in the lyric; and
a feedback button, wherein the feedback button allows the user to indicate whether the user answered the question correctly.

7. The method of claim 1, wherein the translation prompt further comprises:
a question asking the user to translate a word in the lyric:
a first feedback button associated with a correct answer to the question; and
one or more incorrect feedback buttons, the one or more incorrect feedback buttons associated with incorrect answers to the question.

8. The method of claim 1, wherein the translation prompt further comprises:
a question presenting the lyric with a missing word and asking the user to fill in the missing word; and
an activatable control, wherein activation of the activatable control opens an input mechanism configured to receive input from the user to answer the question.

9. The method of claim 8, wherein the input mechanism is a keyboard or an audio recorder.

10. The method of claim 1, wherein the translation prompt further comprises:
a question asking the user if a word in a first language is an accurate translation of a word in the lyric, the word in the lyric being in a second language:
a first feedback button, wherein the first feedback button allows the user to indicate that the word in the first language is an accurate translation of the word in the lyric; and
a second feedback button, wherein the second feedback button allows the user to indicate that the word in the first language is not an accurate translation of the word in the lyric.

11. The method of claim 1, wherein the translation prompt further comprises:
a presentation of the lyric, wherein a word in the lyric is missing, and a translation of the missing word:
a first flashcard user interface presenting a question, the question asking the user to fill in the missing word in the lyric;
a second flashcard user interface presenting the missing word in the lyric; and
a feedback button, wherein the feedback button allows the user to indicate whether the user answered the question correctly.

12. A system for teaching a user a language using media content, the system comprising:
a computing device, the computing device configured to:
play at least a segment of a song, the segment having a lyric:
determine a time at which the lyric will be played; and
present a translation prompt for the lyric at a time that is substantially the same as the time at which the lyric is played,
wherein the translation prompt is automatically presented without an input from the user at a time during which the segment is playing.

13. The system of claim 12, wherein the computing device is further configured to:
generate the translation prompt for the lyric.

14. The system of claim 12, further comprising:
a media delivery system, the media delivery system configured to:
stream the song to the computing device:
determine a timestamp of the time at which the lyric is played; and
determine a translation of the lyric.

15. The system of claim 14, wherein the media delivery system is further configured to:
generate the translation prompt for the lyric; and
transmit the translation prompt to the computing device.

16. The system of claim 14, wherein the computing device is further configured to:
receive input from the user indicating whether the user answered the translation prompt correctly or incorrectly; and
transmit a signal to the media delivery system based on whether the user answered the translation prompt correctly or incorrectly,
wherein the media delivery system updates a user profile based on the signal, the user profile maintained in a database of user profiles in the media delivery system.

17. A media delivery system for teaching a user a language using media content, the media delivery system configured to:
stream at least a segment of a song to a computing device:
select a lyric from the segment, wherein the lyric is based on a skill level of the user and a language learning need of the user:
determine a timestamp of a time at which the lyric is played:
determine a translation of the lyric; and
compile the lyric, the timestamp, and the translation to be used for a translation prompt for the lyric,
wherein the translation prompt for the lyric is automatically presented to the user on the computing device at a time that is substantially the same as the time at which the lyric is played without an input from the user at a time during which the segment is played.

18. The media delivery system of claim 17, further configured to:
generate the translation prompt; and
transmit the translation prompt to the computing device.

19. The media delivery system of claim 17, further configured to:
transmit the lyric, the timestamp, and the translation to the computing device.

20. The media delivery system of claim 17, further configured to:
select the song, wherein the song is selected based on having a lyric that matches a skill level of the user and a language learning need of the user, and the song matching a music taste of the user.
